(19) United States
(12) Patent Application Publication
(10) Pub. No.: US 2002/0088806 A1
(43) Pub. Date: Jul. 11, 2002

(54) High pressure hydrogen tank and the manufacturing method thereof

(75) Inventors: Koichi Takaku, Saitama (JP); Shuichi Togasawa, Saitama (JP); Yasuki Yoshida, Saitama (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: Honda Giken Kogyo Kabushiki Kaisha

(21) Appl. No.: 10/011,434

(22) Filed: Dec. 11, 2001

(30) Foreign Application Priority Data
Dec. 21, 2000 (JP) 2000-388127

(51) Int. Cl. F17C 1/06

(52) U.S. Cl. 220/589

(57) ABSTRACT

To prevent penetrating hydrogen of the hydrogen tank and occurring buckling phenomenon, High-pressure hydrogen tank 10 possesses a liner 11 made of high-density polyethylene. A shell 12 made by winding a fiber-reinforced material for hardening is formed outside of this liner 11 to enhance liner synthesis. Hydrogen barrier layer 14 is piled up inside of the liner 11. This hydrogen barrier layer 14 prevents hydrogen filled in liner 11 from penetrating to outside.

### FIELD OF THE INVENTION

The present invention relates to a high-pressure hydrogen tank to store up hydrogen in the high-pressure and the manufacturing method thereof.

### BACKGROUND OF THE INVENTION

In recent years, a fuel cell electric vehicle is remarkable from the aspect of the environment to restrain the discharge quantity of the carbon dioxide which causes the global warming, and so on. The fuel cell electric vehicle is equipped with the fuel cell which generates electricity, making hydrogen (H₂) and oxygen (O₂) in the air react electrochemically, and the electricity generated by the fuel cell is supplied to the motor for occurring driving force. This fuel cell electric vehicle is equipped with a high-pressure hydrogen tank (a high-pressure hydrogen storage container, hereinafter simply called as “hydrogen tank”) from the reason that the dealing is easy, and soon, compared with liquid hydrogen and so on. Also it is the vehicle, which had an internal combustion engine, but the hydrogen vehicle, the fuel of which is hydrogen instead of petrol, is remarkable too from the aspect of the environment, and also this hydrogen vehicle is equipped with a hydrogen tank from the similar reason.

As the hydrogen tank, which is used with such a fuel cell electric vehicle and the hydrogen vehicle, the one as indicating in FIG. 7 had been come into exist in pervious days. As indicating in FIG. 7, a hydrogen tank 20 is equipped with a body of a container.

A hydrogen tank 20 possesses a high-density resin of an excellent processing, a high mechanical strength, and a high impermeability to hydrogen such as a barrel shaped reign linear 21 made of high-density polyethylene. A carbon fiber as a fiber-reinforced material is winded around this liner 21 to form a shell 22 for enhancing strength. Moreover, top boss 23A and end boss 23B are allocated respectively to front and rear portion of a liner 21. Furthermore, intank solenoid valve SV is installed in top boss 23A.

Since hydrogen tank 20 equipped with such a body of a container is considerably lightweight compared with a tank made of steel or aluminum, it is preferably used for a fuel cell electric vehicle or a hydrogen vehicle having a great demand for lightening. For the sake of this, an actuality of using a hydrogen tank 20 shown in FIG. 7 for a fuel cell electric vehicle or a hydrogen vehicle should be enhanced.

However, as a liner 21 in said conventional hydrogen tank, a high-density polyethylene is used. This high-density polyethylene can display an airtight performance for a natural gas and so on which has a relatively large molecular weight, but hydrogen, which has a small molecular weight, penetrates this polyethylene unless the thickness of a liner 21 is increased. Since it is not desirable that hydrogen penetrates outside hydrogen tank, conventional countermeasure was to make a layer of liner 21 thick.

However, even though making a layer of liner 21 thick, the problem that hydrogen penetrates outside hydrogen tank 20 can be inevitable since penetrating hydrogen can not be prevented completely and also the problem that weight is increased will be arisen. Furthermore, when hydrogen is filled into hydrogen tank 20 in quantities and being in the high-pressure condition, or when impermeability to hydrogen of a shell 22 is higher than that of a liner 21, hydrogen would be left at the high pressure between liner 21 and shell 22. When pressure is declined due to sudden decrease of hydrogen in hydrogen tank 20 by opening intank solenoid valve SV under the condition that hydrogen is left between this liner 21 and a shell 22, hydrogen remaining between a liner 21 and a shell 22 is inflated. Consequently, inflated hydrogen deform and crack a liner 21, what is called, there was a risk of occurring a buckling phenomenon.

Therefore, the object of the present invention is to prevent penetrating hydrogen of hydrogen tank and an occurrence of a buckling phenomenon.

### SUMMARY OF THE INVENTION

The high-pressure hydrogen tank regarding to claim 1 of the present invention which attained said object is characterized by possessing a body of a resin container, into which a high-pressure hydrogen is filled into inside, and hydrogen barrier layer comprising a material of high impermeability to hydrogen is piled up on the innerface of said body of a container.

The present invention regarding to claim 1, the hydrogen barrier layer is formed by a material having a high impermeability to hydrogen on the innerface of a body of a container. This layer is, in other words, a material having a property of hardly permeable to hydrogen, which has higher impermeability than that of a body of a container. For the sake of this, hydrogen filled into high-pressure hydrogen tank can be securely preventable for permeating the hydrogen out of the tank. In this case, as resin comprising a body of a container, a high-density polyethylene, a high-density polypropylene and so on can be preferably used due to appropriate strength, less expensive, easy processing, and what is more, relatively high air tightness.

In addition, when a barrier layer is provided on the outerface of a body of a container, a buckling phenomenon occurs such that hydrogen is left between barrier layer and a body of a container for causing a body of a container to be deformed and cracked due to decompression. However the present invention provides barrier layer on the innerface of a body of a container so that this buckling phenomenon never occurs.

The present invention regarding claim 2 is a high-pressure hydrogen tank described in claim 1 characterized as the outer face of a body of said container is reinforced by a fiber-reinforced material.

There is a possibility that buckling phenomenon occurs if hydrogen penetrates in between the body of a container and a fiber-reinforced material under the condition that the outerface of the body of a container is reinforced by a fiber-reinforced material.

On the other hand, according to the present invention of claim 2, high impermeable material to hydrogen is piled up on the innerface of the body of the container of the high-pressure hydrogen tank in which outerface of the body of the container is reinforced by the fiber-reinforced material. This impermeable material to hydrogen is higher than that of a body of a container. For this reason, being the condition that hydrogen can hardly permeate into between a body of a container and a fiber-reinforced material can effectively prevent a buckling phenomenon from occurring. From a perspective in terms of lightening, strength, processing and prevention of a buckling phenomenon, an impermeability to hydrogen comprises the sequence of high impermeability to hydrogen in which hydrogen barrier layer is highest, a body of a container is second, and a fiber-reinforced material is third.

The present invention regarding to claim 3 is a high-pressure hydrogen tank described in claim 1 or claim 2 characterized that a material formed said hydrogen barrier layer is made of a synthetic rubber.

According to the present invention of claim 3, a hydrogen barrier layer is formed by synthetic rubber, which is preferably used as the hydrogen barrier layer. Since intermolecular of synthetic rubber is thicken, impermeability to hydrogen is very high. Consequently, it is preferable for using it as a material to form a hydrogen barrier layer.

The present invention regarding to claim 4 is the manufacturing method of high-pressure hydrogen tank described in any one of claim 1-3 characterized by dispensing a coating of said hydrogen barrier layer to the inner face of a body of said container.

According to the present invention of claim 4, hydrogen barrier layer is directly coated on the innerface of a body of a container. This method forms a hydrogen barrier layer separately in piling up hydrogen barrier layer, consequently, a high-pressure hydrogen tank can easily be manufactured compared with such as adhering on the inner face of a body of a container.

The present invention regarding to claim 5 is the manufacturing method of a high-pressure hydrogen tank described in any one of claim 1-3 characterized by allocating an expansion member made of a material comprising said hydrogen barrier layer to the inside of said body of a container under the inflatable condition through inflow of the air, and flowing air into a material comprising said hydrogen barrier layer to inflate and pile up in the inner face of said body of a container.

According to the present invention of claim 5, when forming a body of a container, expansion member made of a material comprising a hydrogen barrier layer is allocated into the inside. Inflating this expansion member allows hydrogen barrier layer to pile up on the inner face of a body of a container. Accordingly, since dispensing a coating is not necessary for piling up a hydrogen barrier layer, hydrogen barrier layer can be formed more easily.

### BRIEF DESCRIPTION OF THE DRAWINGS

FIG. 1 is a partial prospective top cutaway view of a fuel cell electric vehicle equipped with a hydrogen tank.

FIG. 2 is a partial cutaway front view of a hydrogen tank.

FIG. 3 is a diagram to indicate the relation of penetration velocity of hydrogen to penetrate a pressure and hydrogen from a hydrogen tank.

FIG. 4 is a diagram to indicate the relation of penetration velocity of hydrogen to penetrate a temperature and hydrogen from a hydrogen tank.

FIG. 5 is a process diagram to schematically indicate the first manufacturing method of a hydrogen tank.

FIG. 6 is a partial cutaway front view to schematically indicate the second manufacturing method of a hydrogen tank.

FIG. 7 is a partial cutaway front view of conventional hydrogen tank.

### DESCRIPTION OF THE PREFERRED EMBODIMENTS

Following is a detailed explanation of the embodiment regarding to the present invention.

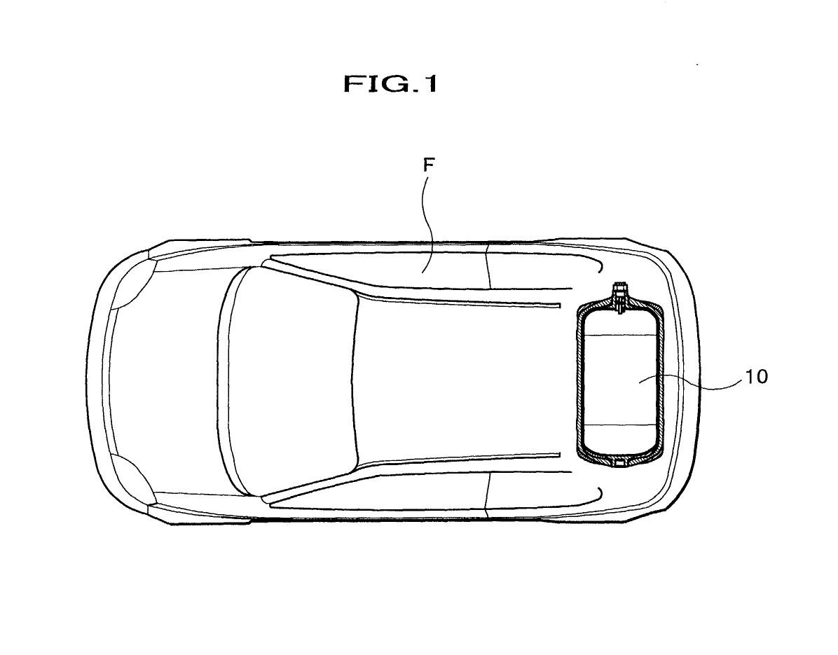

FIG. 1 is a partial perspective top cutaway view of a fuel cell electric vehicle equipped with a hydrogen tank.

A vehicle indicating in FIG. 1 is a fuel cell electric vehicle F, a hydrogen tank 10 is laterally installed on upper portion of rear wheel of rear part of vehicle. Furthermore, this fuel cell electric vehicle F is equipped with fuel cell and motor for running application (not shown). Hydrogen is supplied into fuel cell from a hydrogen tank 10 for generating electricity by allowing oxygen and hydrogen in the air to react electrochemically. The generated electric power is supplied into a motor for running application to run a fuel cell electric vehicle F.

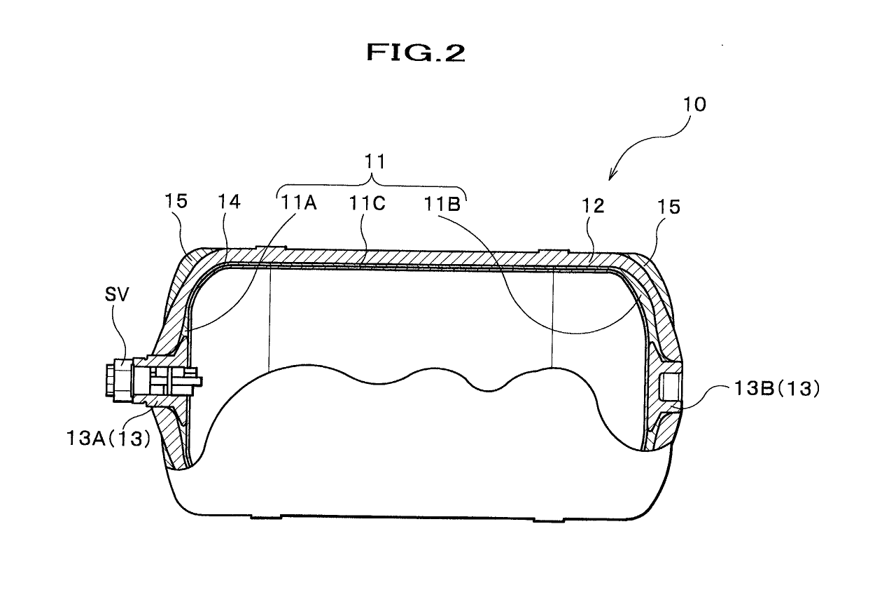

As indicated in FIG. 2, hydrogen tank 10 is a barrel profiled high-pressure hydrogen storage container equipped with liner 11 and shell 12, which are a body of resin container. Furthermore, each boss 13 is formed on both front and rear portion of the body of the container, and in addition, a hydrogen barrier layer 14 is piled up on the inner face of a body of a container.

The liner 11 is comprised of high-density polyethylene as material. A high-density polyethylene possesses not only a characteristic as lightweight and high mechanical strength but also a material to be able to sufficiently maintain a configuration as a tank in spite of lightweight. This allows a tank to be significantly lightening compared with steel one.

This liner 11 has a barrel shape based on the shape of a hydrogen tank 10. Furthermore, the liner 11 plays a roll of securing air tightness (a property of gas barrier) in the hydrogen tank 10. However, since molecular weight of hydrogen is light, a high-density polyphone has an air tightness to some extent, but it can not obtain good air tightness enough to shut hydrogen completely. However, making the thickness of liner 11 comparatively thick such as 10 mm can gain excellent air tightness.

The liner 11 possesses a leading edge 11A, trailing edge 11B and a shell portion 11C positioned in between both edges 11A and 11B. Both edges 11A and 11B have pillow shape to open one side respectively, and a shell portion 11C has a cylindrical shape. Furthermore, a diameter of both edges of 11A and 11B is equal to a diameter of a shell portion 11C. And each aperture of both edges 11A and 11B are allocated as facing each other to pinch a shell portion 11C for dispensing a heat fusion to between aperture of a leading edge 11A and one side aperture of a shell portion 11C. Similarly, dispensing a heat fusion to between aperture of a trailing edge 11B and another side aperture of a shell portion 11C. Through these portion dispensed by a heat fusion, both edge portion 11A and 11B, and a shell portion 11c is connected each other to integrate a liner 11.

A shell 12 is comprised of a fiber-reinforced material, such as FRP and is winded around a liner 11 to reinforce a rigidity of a liner 11. Hydrogen is filled into hydrogen tank 10 by extremely high pressure of around maximum 25 MPa. This capacity is beyond a liner 11 for rigidly and durability, therefore, forming a shell 12 can compensate for enhancing these rigidly and durability. After winding a carbon fiber adhered by epoxy resin around a liner 11, this shell 12 is formed by hardening an epoxy resin. In case of winding a carbon fiber around a liner 11, a liner 11 rotates around a boss 13 as supporting shaft.

The boss 13 is equipped with a top boss 13A and an end boss 13B. These both a top boss 13A and an end boss 13B are comprised of material such as Aluminum alloy of lightweight and high mechanical strength. A top boss 13A possesses penetration hole and is a cylindrical shape equipped with a flange portion on the one side of tip edge. A top boss 13A is fixed on the center of leading edge 11A in a liner 11 as protruding a cylindrical portion.

A penetration hole in a top boss 13A is taped for mounting intank solenoid valve SV. Penetration hole plays a role of outflow and inflow port for hydrogen including filling and discharging hydrogen.

On the other hand, end boss 13B possesses a concave portion to have a cylindrical shape equipped with a flange portion on one side of edge. The end boss 13B is fixed to protrude a cylindrical portion in the center of trailed edge 11B on the liner 11. Furthermore, a concave portion of end boss 13B is taped to allow a supporting shaft (not shown) to mount. This supporting shaft is used to rotate a liner 11 when a carbon fiber is winded around a liner 11.

As hydrogen tank 10 after forming a shell 12 at a peripheral of a liner 11, a top boss 13A exposes a flange shaped tip edge portion in hydrogen tank 10, and protrudes a cylindrical portion over outside the hydrogen tank 10 to secure an air tightness and be fixed. On the other hand, end boss 13B also exposes a flange shaped tip edge in hydrogen tank 10 and protrudes a cylindrical portion over outside of hydrogen tank 10 to secure air tightness and be fixed.

Intank solenoid valve SV possesses a construction equipped with a non return valve for a magnetic actuation of the ON /OFF valve.

ON/OFF valve of magnetic actuation is connected with hydrogen supplying pipe to supply hydrogen into a fuel cell. And based on the control of control unit (not shown), ON (open) and OFF (close) is carried out, hydrogen in hydrogen tank 10 is discharged into hydrogen supplying pipe (a fuel cell) under the condition of ON. On the other hand, discharging hydrogen is halt under the condition of OFF. A non-return valve is connected with an aperture of filling hydrogen (not shown) of fuel cell electric vehicle in FIG. 1.

Subsequently, applying the higher pressure than inside pressure of hydrogen tank 10 to a non-return valve causes opening regardless of the condition of ON/OFF valve of magnetic actuation. On the other hand, applying only lower pressure than inside hydrogen tank 10 to non-return valve causes closing (usually closed). Filling hydrogen is carried out via this non-return valve. In other words, ON/OFF valve of magnetic actuation is of function when discharging hydrogen, non return valve is function when filling hydrogen.

Hydrogen barrier layer 14 is high impenetrability to hydrogen, in other words, it is a material of low coefficient for gas penetration and comprised of a material having high impenetrability to hydrogen under the condition of using temperature for hydrogen tank 10. As this material, concretely, synthesis rubber such as nitric rubber (NBR), fluorine rubber (FKM), hydrogenation nitric rubber (NEM) and so forth is preferably used. High airtight resin such as nylon is also available as other example.

Furthermore, such as tough shellform 15 made of polyurethane is attached on the shoulder portion of front and rear of shell 12.

Following is explanation of the function of hydrogen tank having above construction.

Regarding to the hydrogen tank 10 of the present invention, hydrogen is filled in hydrogen tank 10 via intank solenoid valve SV. Filling hydrogen into hydrogen tank 10 causes inside hydrogen tank 10 to be extremely high pressure of approximately maxim 25 MPa. Hydrogen molecular tries to penetrate a liner 11 and a shell 12 through this pressure. However, hydrogen barrier layer 14 of impenetrability to hydrogen is formed in hydrogen tank 10. Since this does not allow hydrogen in the hydrogen tank 10 to penetrate hydrogen barrier layer 14, penetrating hydrogen from hydrogen tank 10 can be prevented.

What is more, since hydrogen barrier layer 14 does not enter between a liner 11 and a shell 12 due to piling up in the inner facing of liner 11. Accordingly, for example, even though the pressure inside hydrogen tank 10 is decreased due to sudden evacuating hydrogen from inside hydrogen tank 10, inflating hydrogen between a liner 11 and a shell 12 never occurred. Consequently, buckling phenomenon can be securely prevented.

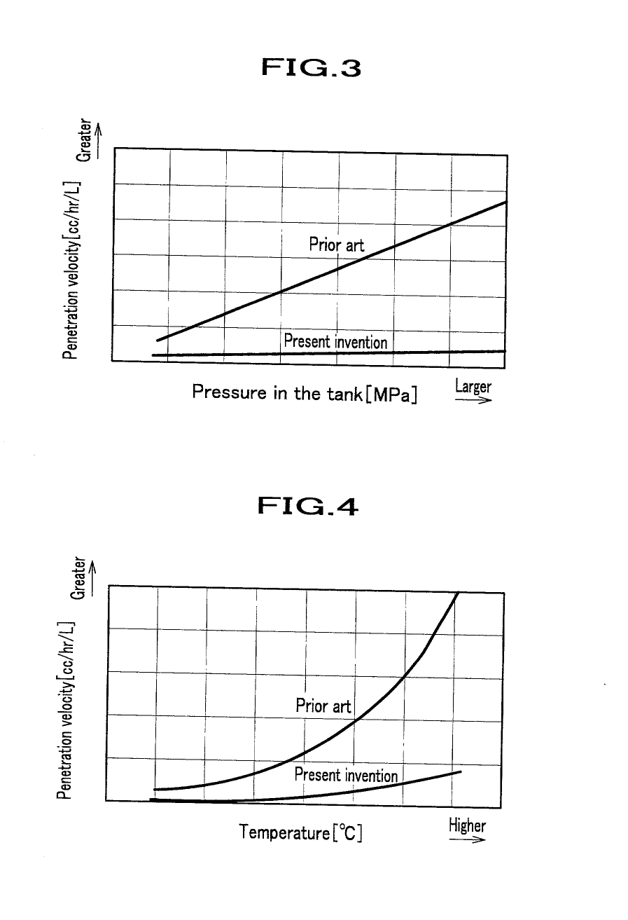

Now, following is description of the effect of the present invention with referencing to FIGS. 3 and 4. The inventors of the present invention carried out the experiment to examine impermeability of hydrogen in hydrogen tank regarding to the present invention. The experiment was carried out by using hydrogen tank 10 indicated in this embodiment. Concretely, the quantity of hydrogen (penetration velocity) penetrating from hydrogen tank 10 per hour is measured with varying pressure and temperature in hydrogen tank 10.

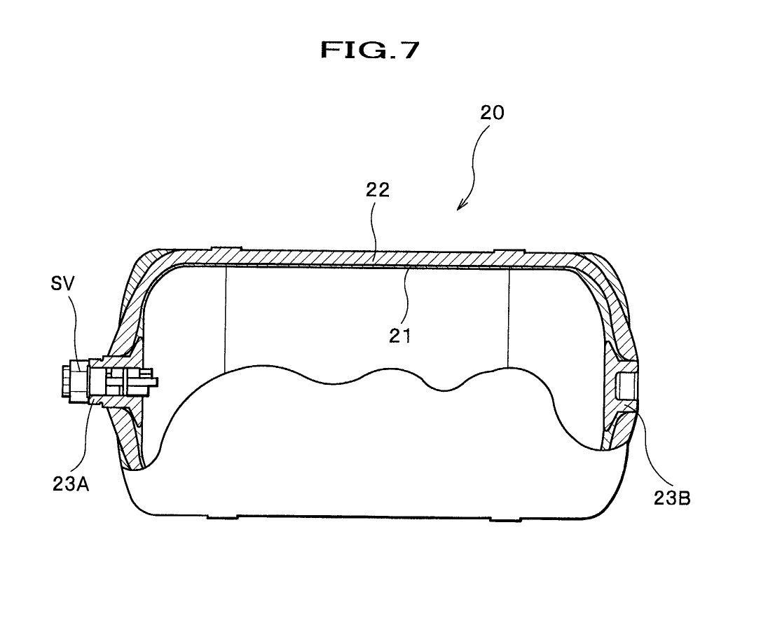

Furthermore, also for the conventional hydrogen tank 20 indicated in FIG. 7, similarly, the quantity of hydrogen penetrating from hydrogen tank 20 is measured with varying pressure and temperature in hydrogen tank 20. The results are shown in FIG. 3 and FIG. 4.

As indicated in FIG. 3, in hydrogen tank 20 regarding to prior art, as the pressure in hydrogen tank 20 is increased, the penetration velocity of hydrogen is increased in proportion of the increasing pressure. Accordingly, the quantity of the hydrogen, which the pressure in hydrogen tank 20 penetrates into as much as being high, increases.

On the other hand, in case of hydrogen tank 10 regarding to the present invention, even though the temperature in the hydrogen tank 10 is increased, a penetration velocity of hydrogen penetrating from hydrogen tank 10 was slightly increased only. The results assured that hydrogen hardly penetrates from hydrogen tank 10 even though the pressure in hydrogen tank 10 is increased.

What is more, as indicated in FIG. 4, in hydrogen tank 20 regarding to prior art, as the temperature in hydrogen tank is increased, penetration velocity of hydrogen is accelerated to increase in accordance with increasing the temperature. Therefore, The quantity of the hydrogen, which the pressure in hydrogen tank 20 penetrates into as much as being high, increases.

On the other hand, in case of hydrogen tank 10 regarding to the present invention, even though the temperature in the hydrogen tank 10 is increased, a penetration velocity of hydrogen penetrating from hydrogen tank 10 was slightly increased only. The results assured that hydrogen is hardly penetrated from hydrogen tank 10 even though the temperature in hydrogen tank 10 is increased.

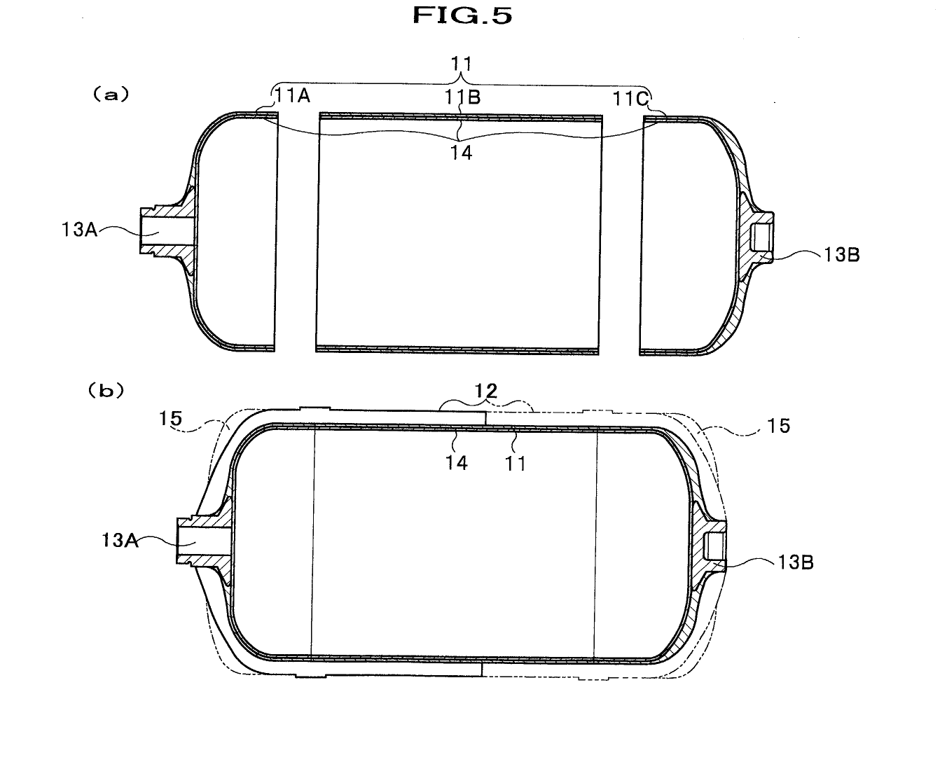

Subsequently, following is the explanation of the manufacturing method of hydrogen tank regarding to the present invention. First of all, the first manufacturing method is explained. The first manufacturing method is as indicated in FIG. 5(a), to separately form a leading edge 11A, a trailing edge portion 11B and a shell portion 11C comprising liner 11 by such as injection mold. Of these, top boss 13A is formed in leading edge portion 11A, on the other hand, end boss 13B is formed in the trailing edge 11B. Secondly, synthetic rubber making up hydrogen barrier layer 14 and having an impenetrability to hydrogen is sprayed to inside face of leading edge 11A, trailing edge 11B and shell portion 11C respectively for coating.

Continuously, the heat fusion is dispensed to between aperture of a leading edge 11A and one side aperture of a shell portion 11C of liner 11 and between aperture of a trailing edge 11B and another side aperture of a shell portion 11C of liner 11 respectively. In this way, the liner 11, in which a hydrogen barrier layer 14 is formed inside, is configured.

After liner 11 was formed, subsequently, as indicated in FIG. 5(b), with rotating a liner 11, winding a carbon fiber comprising a shell 12 around the outer face of a liner 11 in which an epoxy resin adhered to. After a carbon fiber is winded around all face of outside liner 11 in this way, an epoxy resin is hardened to form a shell 12.

After a shell 12 is formed, intank solenoid valve SV is attached to leading edge 11A of liner 11, in addition, tough shell forms 15 are attached to a shoulder portion on front and rear of a shell 12. Hydrogen tank 10 is formed in this way. Before forming a liner 11 like this, coating a material forming a hydrogen barrier layer 14 to inside allows a hydrogen barrier layer 14 to be formed easily inside of a liner 11.

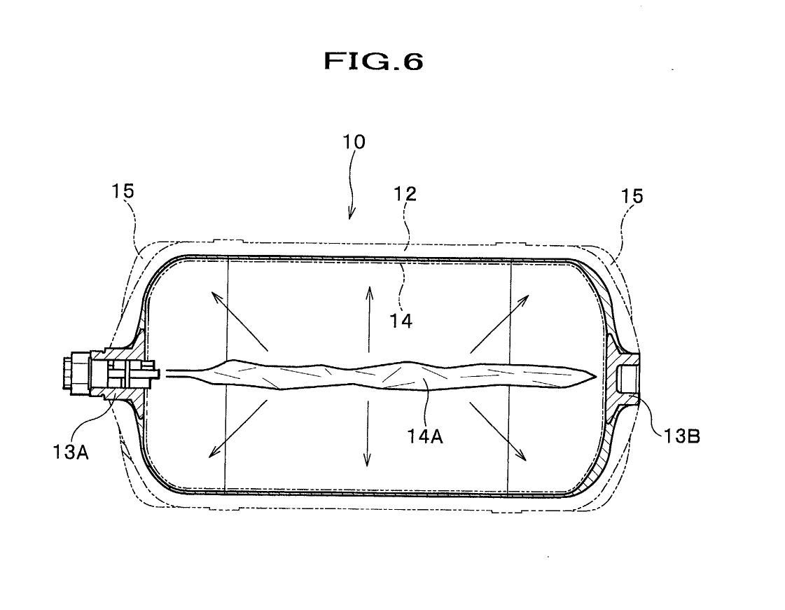

Subsequently, following is the explanation of the second manufacturing method. Like the first manufacturing method, the second manufacturing method is to separately form a leading edge 11A, a trailing edge portion 11B and a shell portion 11C comprising liner 11 by such as injection mold. Also, in the second manufacturing method, as indicated in FIG. 6, in parallel with this, a ballroom shaped expansion member 14A is formed by a material comprising of hydrogen barrier layer 14. This expansion member 14A is to inflate by inflow of air. Continuously, the heat fusion is dispensed to between aperture of a leading edge 11A and one side aperture of a shell portion 11C of liner 11 and between aperture of a trailing edge 11B and another side aperture of a shell portion 11C of liner 11 respectively under the condition of attaching this air inflow port of expansion member 14A to top boss 13A of leading edge 11A comprising a liner 11. In this way, a liner 11 is formed. After forming a liner 11, air from inlet port of expansion member 14A is supplied to inflate expansion member 14A. When expansion member 14A is inflated, this expansion member 14A closes together inside of liner 11 to be condition of covering inside of liner 11. Consequently, expansion member 14A and liner 11 is connected as example, hydrogen barrier layer 14 is piled up in the inner face of liner 11.

In this way, when hydrogen barrier layer 14 is piled up in the inner surface of liner 11, winding a carbon fiber comprising a shell 12 around outside face of liner 11 with rotating a liner 11 in the same way of the first manufacturing method. Winding carbon fiber around all outside face of liner 11 in this way, hardening epoxy resin to form a shell 12.

When shell 12 is formed, with attaching intank solenoid valve SV to leading edge 11A of liner 11, at the same time, tough shellforms 15 is attached to a shoulder portion in front and rear of a shell 12.

Hydrogen tank 10 is formed in this way. When liner 11 is formed, piling up hydrogen barrier layer 14 through inflating an expansion member 14A causes easy manufacturing method because there is no process for coating a material comprising hydrogen barrier lay 14 compared with said first manufacturing method.

Above mention was the explanation of preferable embodiment of the present invention, but the present invention is not restricted to said embodiment. For instance, though the example of equipping hydrogen tank with a fuel cell electric vehicle was explained, other use is available. Furthermore, of course another method of manufacturing hydrogen tank except for one indicated in said embodiment can be acceptable.

What is more, such as natural rubber can be used except for said synthesis rubber as a material comprising hydrogen barrier layer. However, since a natural rubber is less superior to a synthesis lubber in terms of such as refractory, using a synthesis rubber is preferable. On the other hand, when forming a hydrogen barrier layer in the inner face of liner, coating a raw material forming a hydrogen barrier lay is available. Furthermore, it is of course needless to say that forming hydrogen barrier layer on all over the inner face of liner is preferable, but forming on one portion of the inner face of a liner is also available.

As described above, according to the invention regarding to claim 1 of the present invention, penetrating hydrogen filled in a high-pressure hydrogen tank to outside can be securely preventable.

According to the present invention of claim 2, this causes making the condition that hydrogen can hardly penetrate between a body of a container and a fiber-reinforced material, therefore buckling phenomenon can be effectively prevented.

According to the present invention of claim 3, since a synthesis rubber is used as a material forming hydrogen barrier layer, high impenetrability to hydrogen can be obtained which can securely prevent hydrogen from being penetrated.

According to the present invention of claim 4, high-pressure hydrogen tank can be easily manufactured. According to the present invention of claim 5, high-pressure hydrogen tank can be more easily manufactured.

What is claimed is:

1. A high-pressure hydrogen tank comprising a body of a resin container in which a high pressure hydrogen is filled into inside, and a hydrogen barrier layer made of a material of higher impenetrability to hydrogen than that of said body of a container is piled up on the inner face of said body of a container.

2. A high-pressure hydrogen tank as set forth in claim 1 wherein outer face of said body of a container is reinforced by a fiber-reinforced material, and an impermeability to hydrogen has the sequence of high impermeability to hydrogen in which hydrogen barrier layer is highest, a body of a container is second, and a fiber-reinforced material is third.

3. A high-pressure hydrogen tank as set forth in claim 1 or claim 2 wherein a material forming said hydrogen barrier layer is made of a synthesis rubber.

4. A manufacturing method of high pressure hydrogen tank as set forth in any one of claims 1-3 wherein said hydrogen barrier layer is coated on the inner face of said body of a container.

5. A manufacturing method of high pressure hydrogen tank as set forth in any one of claims 1-3 characterized by positioning an expansion member made of a material making up said hydrogen barrier layer inside of said body of a container under the inflatable condition by inflow of air, and piling up a material making up said hydrogen barrier layer on the inner face of said body of a container after inflating by inflow of air.
